(19) United States
(12) Patent Application Publication
(10) Pub. No.: US 2025/0155621 A1
(43) Pub. Date: May 15, 2025

(54) MULTILAYER OPTICAL COATING WITH METASTRUCTURES

(71) Applicant: VIAVI Solutions Inc., Chandler, AZ (US)

(72) Inventor: Markus BILGER, Santa Rosa, CA (US)

(21) Appl. No.: 18/946,380

(22) Filed: Nov. 13, 2024

Related U.S. Application Data
(60) Provisional application No. 63/599,255, filed on Nov. 15, 2023.

(51) Int. Cl. G02B 5/28

(52) U.S. Cl. CPC G02B 5/28

(57) ABSTRACT

In some implementations, an optical filter assembly includes a first optical element disposed on a first side of a substrate, wherein the first optical element includes a first metasurface structure; a second optical element disposed on a second side of the substrate, wherein the second optical element includes a second metasurface structure; and a multi-layer optical coating disposed between the first optical element and the second optical element.

### CROSS-REFERENCE TO RELATED APPLICATION

This Patent application claims priority to U.S. Provisional Patent Application No. 63/599,255, filed on Nov. 15, 2023, and entitled “MULTILAYER OPTICAL COATING WITH METASTRUCTURES.” The disclosure of the prior Application is considered part of and is incorporated by reference into this Patent Application.

### BACKGROUND

A metastructure may include a planar surface that includes a sub-wavelength patterned structure to perform an optical functionality. The sub-wavelength structures, which may be referred to as “nanopillars,” may interact with light to cause the metastructure to perform an optical functionality, such as a lens functionality, a filter functionality, or a grating functionality, among other examples. Metasurfaces may be configured to alter a phase, a wavelength, an amplitude, or a polarization orientation of light. Examples of metasurfaces include metalenses, meta-holograms, or polarization optics, among other examples.

### SUMMARY

In some implementations, an optical filter assembly includes a first optical element disposed on a first side of a substrate, wherein the first optical element includes a first metasurface structure; a second optical element disposed on a second side of the substrate, wherein the second optical element includes a second metasurface structure; and a multi-layer optical coating disposed between the first optical element and the second optical element.

In some implementations, a method includes depositing, by a device, an optical filter structure on a surface of a substrate, wherein the optical filter structure includes a first one or more layers of a first material and a second one or more layers of a second material; depositing, by the device, a material layer on top of the optical filter structure, such that the optical filter structure is positioned between the material layer and the substrate; and forming, by the device, a metastructure on a surface of the material layer.

In some implementations, an optical system includes an electro-optic component; and a composite optical filter aligned to the electro-optic component, the composite optical filter including: a first optical metastructure on a first side of the composite optical filter; a second optical metastructure on a second side of the composite optical filter; and a multi-layer optical filter disposed between the first optical metastructure and the second optical metastructure.

### BRIEF DESCRIPTION OF THE DRAWINGS

FIG. 1 is a diagram of an example implementation described herein.

FIG. 2 is a diagram of an example implementation associated with a multilayer optical coating with metastructures.

FIG. 3 is a flowchart of an example process associated with manufacturing a multilayer optical coating with metastructures.

### DETAILED DESCRIPTION

The following detailed description of example implementations refers to the accompanying drawings. The same reference numbers in different drawings may identify the same or similar elements.

An optical sensor device may include a sensor element array of sensor elements to receive light initiating from an optical source, such as an optical emitter, an optical transmitter, a light bulb, an ambient light source, and/or the like. For example, in a spectrometer, the optical sensor device may include an array of sensor elements to receive light reflected off a target object, thereby enabling an identification of the target object. A sensor element may be associated with an optical filter that filters light to the sensor element to enable the sensor element to obtain information regarding a particular spectral range of electromagnetic frequencies. For example, the sensor element may be aligned with an optical filter with a passband in a near-infrared (NIR) spectral range, a visible spectral range, an ultraviolet spectral range, and/or the like.

A metastructure, which may also be referred to as a “metasurface structure” or an “optical metastructure,” is a set of sub-wavelength structures on a surface that interact with light to alter a characteristic of the light. For example, a set of nanopillars may be disposed on a surface to form an optical element, such as an optical element that alters a direction of light, a wavelength of light, a polarization orientation of light, a phase of light, or an amplitude of light. An optical device, which includes a metastructure, may form an optical lens, an optical grating, an optical mirror, an optical combiner, or an optical splitter, among other examples. Metastructures may provide improved accuracy and/or control of optical characteristics for an optical system. However, when metastructures are integrated with other optical elements, alignment errors may result in poor optical performance. For example, the higher degree of control and/or sensitivity offered by metastructures may result in greater levels of performance degradation as a result of poor alignment with other optical elements in an optical system.

Some implementations described herein provide an optical filter assembly, optical device, optical element, optical module, optical system, and/or the like with an optical filter integrated with one or more metastructures. For example, an optical filter assembly may include a first optical element, which forms a first metastructure, a second optical element, which forms a second metastructure, and a multi-layer optical coating, which forms an optical filter. By monolithically integrating an optical filter into the same structure as a metastructure, the optical filter assembly may reduce a size, weight, and/or manufacturing cost associated with an optical system that includes both a metastructure and an optical filter (e.g., relative to providing the metastructure in a first structure and the optical filter in a second structure). Additionally, or alternatively, by integrating the optical filter and the metastructure into the same stackup, a greater degree of alignment may be achieved, which may provide improved performance for optical systems that include metastructures.

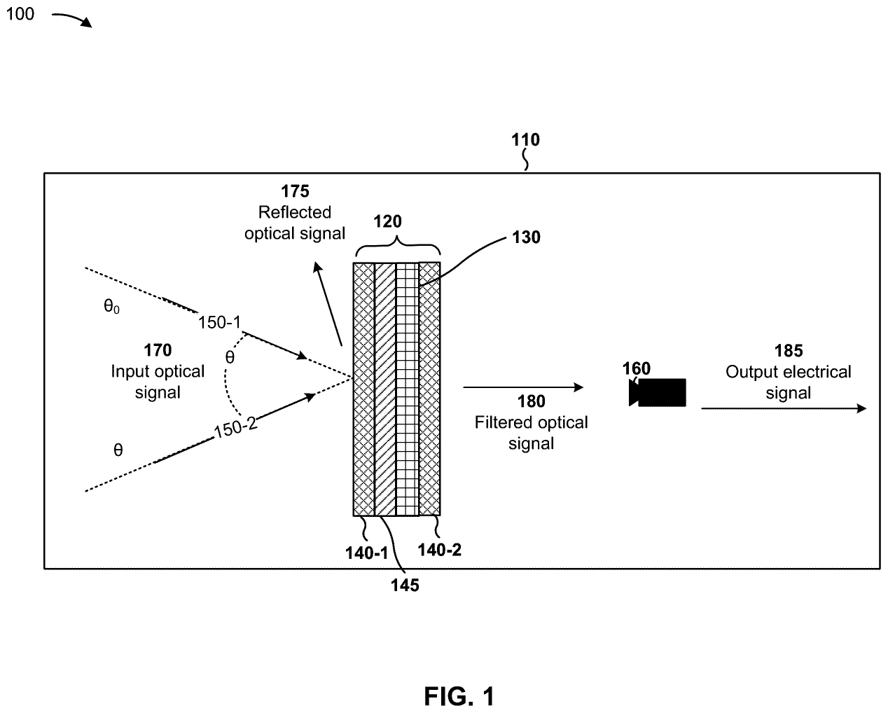

FIG. 1 is a diagram of an example implementation 100 described herein. As shown in FIG. 1, example implementation 100 includes an optical device 110. The optical device 110 may be a portion of an optical system and may provide an electrical output corresponding to a sensor determination. For example, the optical device 110 may be a portion of a LIDAR system, a three-dimensional sensing system, a spectroscopic system, a gesture recognition system, a facial recognition system, an object recognition system, an imaging system, an iris recognition system, a motion tracking system, or a communications system, among other examples.

In some implementations, the optical device 110 may include an optical filter assembly 120. The optical filter assembly 120 may include a substrate 130, a set of optical elements 140 (e.g., a first optical element 140-1 and a second optical element 140-2), and a multi-layer optical coating 145. In some implementations, the optical filter assembly 120 may include one or more metastructures. For example, a first surface of the optical filter assembly 120 (e.g., an outer surface of the first optical element 140-1, such as the surface shown on the left side of the optical filter assembly 120) may form a first metastructure. Additionally, or alternatively, a second surface of the optical filter assembly 120 (e.g., an outer surface of the second optical element 140-2, such as the surface shown on the right side of the optical filter assembly 120) may form a second metastructure. In some implementations, one or more metastructures of the optical filter assembly 120 may provide one or more optical functionalities for the optical device 110. For example, one or more metastructures of the optical filter assembly 120 may form a lens, a filter, a grating, a mirror, a combiner, or a splitter, among other examples. In this case, the one or more metastructures may alter a direction, intensity, wavelength, phase, or amplitude of light incident thereon or passing therethrough.

In some implementations, the optical filter assembly 120 may include a single optical function provided by multiple different metastructures. For example, the first optical element 140-1 may include a first metastructure and the second optical element 140-2 may include a second metastructure, and the first metastructure and the second metastructure may collectively form a single optical element, such as a single lens, a single splitter, a single combiner, or a single filter, among other examples. In this case, by providing parts of the single optical function via multiple metastructures, the optical filter assembly 120 may provide an optical function that is difficult to control or achieve via a single metastructure.

In some implementations, the optical filter assembly 120 may include multiple different optical functions associated with multiple different metastructures. For example, the first optical element 140-1 may include a first metastructure that operates as a first lens and the second optical element 140-2 may include a second metastructure that operates as a second lens, which is separate from and/or different from the first lens. In this case, by disposing the first lens as a first surface of the optical filter assembly 120 and the second lens as a second surface of the optical filter assembly 120, an alignment between the first lens and second lens is controllable to a high degree of accuracy using layer manufacturing techniques and is resistant to misalignment over time (e.g., based on the alignment being fixed by being disposed on a common substrate 130). In other words, relative to a pair of lenses that are formed on separate substrates and aligned by pick-and-place alignment, lenses formed on opposing surfaces of the optical filter assembly 120 may maintain better alignment over time. Similarly, a distance between the lenses on opposing surfaces of the optical filter assembly 120 is controllable to a high degree of accuracy by controlling a thickness of the substrate 130 and/or the multi-layer optical coating 145. In this case, the substrate 130 and/or the multi-layer optical coating 145 can form a spacer between the pair of lenses to maintain optical alignment between the pair of lenses.

Although some implementations are described herein in terms of a pair of lenses, other combinations of optical elements are contemplated, such as the optical elements 140-1 and 140-2 forming a lens and a splitter, a combiner and a filter, a pair of splitters, a pair of combiners, or some other combination of optical elements. Additionally, or alternatively, although some implementations are described in terms of two metastructures formed from two optical elements 140, other quantities of metastructures are contemplated, such as a single metastructure, three or more metastructures, or another quantity of metastructures.

In some implementations, the optical filter assembly 120 may include a filter. For example, the multi-layer optical coating 145 may form a type of filter, such as a bandpass filter. In this case, the multi-layer optical coating 145 may include a set of layers forming a bandpass interference filter that is configured to pass through a first portion of light at a first range of wavelengths and block a second portion of light at a second range of wavelengths, as described in more detail herein. Additionally, or alternatively, the multi-layer optical coating 145 may include a long wavelength passband (LWP) filter, a short wavelength passband (SWP) filter, a low angle-shift (LAS) bandpass filter, a hyper-low angle shift (HLAS) bandpass filter, a broad wavelength passband (BWP) filter, an infrared (IR) cut-off (IR Cut) filter, a notch filter, and/or the like. In some implementations, the multi-layer optical coating 145 may have a bandpass of between 200 nanometers (nm) and 14000 nm and may be used in a visible spectral range, an NIR spectral range, a midwave infrared (MWIR) spectral range, an longwave infrared (LWIR) spectral range, an ultraviolet spectral range, and/or the like.

In some implementations, the multi-layer optical coating 145 may include three or more layers forming an angle-shift filter. For example, the multi-layer optical coating 145 may include a set of layers forming an angle-sensitive filter that is configured to pass through a first portion of light at a first range of angles of incidence (e.g., without a shift to a wavelength of the first portion of light) and to shift a wavelength of a second portion of light at a second range of angles of incidence. In this case, by shifting the wavelength of the second portion of light, the multi-layer optical coating 145 may ensure that stray light, which enters the optical device 110, is not at a wavelength of interest for the optical device 110. In other words, when the optical device 110 is configured to measure a characteristic of light at a wavelength of, for example, 980 nm, the angle-sensitive filter ensures that light with a normal angle of incidence (e.g., a 0 degree angle of incidence, ±10 degrees) is not shifted, but light with a threshold angle of incidence (e.g., greater than 10 degrees or less than −10 degrees) is shifted to a different wavelength (e.g., to a configured center wavelength of 900 nm or 1100 nm). Accordingly, by shifting a wavelength of the second portion of light, the first portion of light can be measured without (or with a reduced amount of) noise or cross-talk from the second portion of light.

In some implementations, the multi-layer optical coating 145 may include one or more other types of filters. For example, the multi-layer optical coating 145 may include an anti-reflectance filter that is configured for the same bandpass region as other optical elements of the optical filter assembly 120. Although some implementations are described in terms of a filter being formed from multiple layers, it is contemplated that some filters, within the optical filter assembly 120, may be formed from a single layer, such as a single thin film layer. Additionally, or alternatively, although some implementations are described herein in terms of a single multi-layer optical coating 145, it is contemplated that the optical filter assembly 120 may include multiple multi-layer optical coatings 145 providing one or more filtering functionalities. In this case, multiple multi-layer optical coatings 145 may be disposed contiguously (e.g., stacked on top of each other) or may be distributed (e.g., disposed on different sides of the substrate 130).

Although some implementations described herein may be described in terms of one or more optical filters, elements, or metastructures in a sensor system, some (other) implementations may be used in another type of system, in an optical component external to a sensor system, in an optical component of an optical package, and/or the like. In some implementations, the optical device 110 may include or be included in a photo detector system, an avalanche photo detector system, a single-photon avalanche diode (SPAD) detector system, or a complementary metal oxide semiconductor (CMOS) detector system.

As further shown in FIG. 1, and as shown by reference number 170, an input optical signal 150 is emitted and directed toward optical filter assembly 120 at one or more angles of incidence, θ. For example, input optical signals 150-1 and 150-2 may be directed toward optical filter assembly 120 at angles of incidence θ₀ (e.g., a configured angle of incidence) and θ. As shown by reference number 175, a first portion of the input optical signal is reflected by optical filter assembly 120. For example, based on a portion of the input optical signal being outside of a passband of a bandpass filter of the multi-layer optical coating 145, the multi-layer optical coating 145 may reflect the portion of the input optical signal.

As further shown in FIG. 1, and by reference number 180, another portion of the optical signal is transmitted through optical filter assembly 120. For example, a portion of the input optical signal within the passband of the multi-layer optical coating 145 (e.g., when the multi-layer optical coating 145 provides a bandpass filtering functionality) is passed through optical filter assembly 120, as described in more detail herein. Additionally, or alternatively, some of the portion of the input optical signal may be angle-shifted and/or blocked. For example, when the multi-layer optical coating 145 is an angle-selective filter, light at angle of incidence θ₀ that passes through the optical filter assembly 120 is unshifted and/or passed through. In contrast, light at angles of incidence having an absolute value of θ or greater is angle shifted and/or blocked. Accordingly, in this example, the portion of the input optical signal passing through the optical filter assembly 120 includes a first sub-portion that is unshifted or unblocked and a second sub-portion that is shifted or blocked.

Although the terms “unshifted” or “unblocked” and “shifted” or “unblocked” are used, all filter spectra may be shifted or blocked by some amount (e.g., a configured percentage) and “unshifted” or “unblocked” light may include light for which a filter spectrum is shifted by less than or equal to a threshold amount or that has greater than or equal a threshold percentage of transmission, and “shifted” may include light for which a filter spectrum is shifted by greater than the threshold amount or that is transmitted by less than the threshold percentage.

In some implementations, a portion of the input optical signal is reflected, split, combined, focused, or otherwise modified by the optical elements 140. For example, metastructures of the optical elements 140 may alter a direction, wavelength, phase, amplitude, or intensity of the input optical signal 150.

As shown by reference number 185, based on a portion of the input optical signal being passed to an optical sensor 160 (e.g., an optical detector or photo detector), optical sensor 160 may provide an output electrical signal for optical device 110. For example, optical sensor 160 may provide an output electrical signal identifying an intensity of light, a characteristic of light (e.g., a spectroscopic signature), a wavelength of light, and/or the like. In some implementations, the optical sensor 160 may perform a measurement of only a sub-portion of light. For example, the optical sensor 160 may perform a measurement of the light that passes the filter at low angle and may not perform a measurement of the light that is reflected or blocked at the filter at high angles. Additionally, or alternatively, the optical sensor 160 may perform a measurement of the light, but the optical sensor 160 may be configured such that an amount of noise or cross-talk in the measurement resulting from the shifted light is less than a threshold amount of noise or cross-talk.

As indicated above, FIG. 1 is provided merely as an example. Other examples may differ from what is described with regard to FIG. 1.

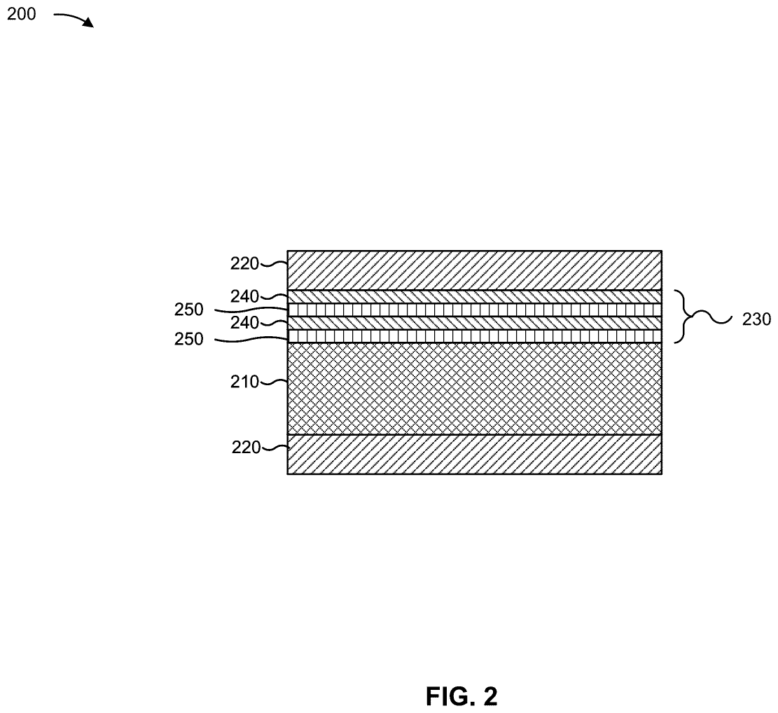

FIG. 2 is a diagram of an example implementation 200 associated with a multilayer optical coating with metastructures. As shown in FIG. 2, example implementation 200 includes a substrate 210, a set of metasurface structures 220 (e.g., optical elements with metastructures formed thereon), and a multi-layer optical coating 230. The multi-layer optical coating 230 may include a first set of layers 240 (e.g., of a first material) and a second set of layers 250 (e.g., of a second material). Although the multi-layer optical coating 230 is depicted as having four approximately equal thickness layers, it is contemplated that other quantities of layers and/or different thickness layers are possible.

In some implementations, substrate 210 may be a transparent substrate, such as a glass substrate, a silicon substrate, a germanium substrate, and/or the like. In some implementations, substrate 210 may be a silicon dioxide substrate. In some implementations, a thickness of the substrate 210 may be selected to configure a particular spacing between metasurface structures 220 (e.g., to optically align the metasurface structures 220).

In some implementations, the substrate 210 may be disposed between the set of metasurface structures 220. For example, the substrate 210 may have a first metasurface structure 220 (e.g., a first lens) disposed on a first side (e.g., the top side) or surface of the substrate 210, and a second metasurface structure 220 (e.g., a second lens) disposed on a second side (e.g., the bottom side) or surface of the substrate 210, such that the substrate 210 is sandwiched by the metasurface structures 220. In this case, as shown, the multi-layer optical coating 230 may be disposed between a metasurface structure 220 and the substrate 210.

Additionally, or alternatively, both the first metasurface structure 220 and the second metasurface structure 220 (in either order) may be disposed on the same side of a substrate 210 (or an unpatterned side of a first metasurface structure 220 may form the substrate for and/or be patterned to form the second metasurface structure 220). In other words, in some implementations, substrate 210 may be omitted. For example, a first lens metasurface structure may be disposed directly on a back of a second lens metasurface structure without a substrate therebetween or onto which nanopillars of each metasurface structure are formed. In some implementations, rather than a substrate separating the metasurface structures 220, another medium may separate the metasurface structures 220, such as the multi-layer optical coating 230, an air gap, a gaseous gap, or a liquid gap, among other examples.

In some implementations, the metasurface structures 220 may include respective patterned surfaces. For example, a metasurface structure 220 may include a material that is patterned with a set of sub-wavelength nanopillars that interact with an optical beam to alter a characteristic of the optical beam, such as a direction, wavelength, amplitude, intensity, or phase, among other examples. The sub-wavelength nanopillars may be arranged in a configured pattern that causes a desired interaction with the optical beam. For example, the nanopillars may be arranged in a grid arrangement (e.g., a regular or repeating pattern) or an irregular arrangement (e.g., a non-repeating pattern), among other examples.

In some implementations, the metasurface structures 220 may be formed from a particular material. For example, a metasurface structure 220 may include a layer of amorphous silicon that is patterned, etched, or imprinted to form a metastructure. Additionally, or alternatively, a metasurface structure 220 may be formed from one or more layers of niobium, tantalum, or titanium, silicon carbide, among other examples. In this case, a material from which to manufacture a metasurface structure 220 may be selected to achieve, for example, a relatively high refractive index (e.g., a refractive index greater than 2.0, greater than 2.5, greater than 3.0, or greater than 3.5, among other examples), a relatively high transmissivity at a wavelength of interest (e.g., greater than 50%, greater than 90%, greater than 95%, or greater than 99%), or a relatively low extinction coefficient, among other examples. In some implementations, a thickness of a metasurface structure 220 may be in a range of approximately 100 nm to approximately 1000 nm.

In some implementations, the multi-layer optical coating 230 may include a set of alternating high refractive index layers and low refractive index layers (e.g., an alternating arrangement of multiple high refractive index layers and multiple low refractive index layers). For example, the first set of layers 240 may include a high refractive index material, such as amorphous silicon or niobium titanium oxide, among other examples. Additionally, or alternatively, the first set of layers 240 may include a silicon layer, a silicon dioxide layer, a hydrogenated silicon layer, a tantalum pentoxide layer, a niobium pentoxide layer, a germanium layer, a silicon germanium layer, a hydrogenated silicon germanium layer, a niobium tantalum oxide layer, a titanium dioxide layer, a silicon nitride layer, or an aluminum nitride layer, among other examples. Additionally, or alternatively, the first set of layers 240 may include another type of high refractive index material layer with a refractive index of greater than 2.0, greater than 2.5, greater than 3.0, greater than 3.5, and/or the like.

In some implementations, the second set of layers 250 may include a low refractive index material, such as silicon dioxide. Additionally, or alternatively, the second set of layers 250 may include another type of low refractive index material layer with a refractive index of less than 2.5, less than 2.0, less than 1.5, and/or the like. For example, the second set of layers 250 may include a set of alternating layers of amorphous silicon layers and silicon dioxide layers for a bandpass filter operating at 940 nm and a set of alternating layers of tantalum oxide layers and silicon oxide layers for an angle-sensitive filter. In some implementations, respective refractive indices of the first set of layers 240 and the second set of layers 250 may differ by at least a threshold difference. For example, the first set of layers 240 may have a first refractive index with a first value and the second set of layers 240 may have a second refractive index with a second value. In this case, the first value may be greater than the second value by at least a threshold difference, such as by at least 0.5, at least 1.0, at least 2.0, or at least 3.0 among other examples.

In some implementations, the multi-layer optical coating 230 may include three or more different materials. For example, the multi-layer optical coating 230 may have a subset of hydrogenated silicon layers, a subset of tantalum pentoxide layers, and a subset of silicon dioxide layers. In this case, using three or more different types of layers may enable the multi-layer optical coating 230 to achieve a higher transmissivity and/or a reduced angle shift at some wavelengths, relative to using only two different materials. In some implementations, the multi-layer optical coating 230 may have a particular pattern of layers. Such as having alternating or interleaved layers 240 and 250. Additionally, or alternatively, the multi-layer optical coating 230 may have one or more space layers disposed between one or more layers 240 and/or layers 250.

As indicated above, FIG. 2 is provided as an example. Other examples may differ from what is described with regard to FIG. 2. The number and arrangement of devices shown in FIG. 2 are provided as an example.

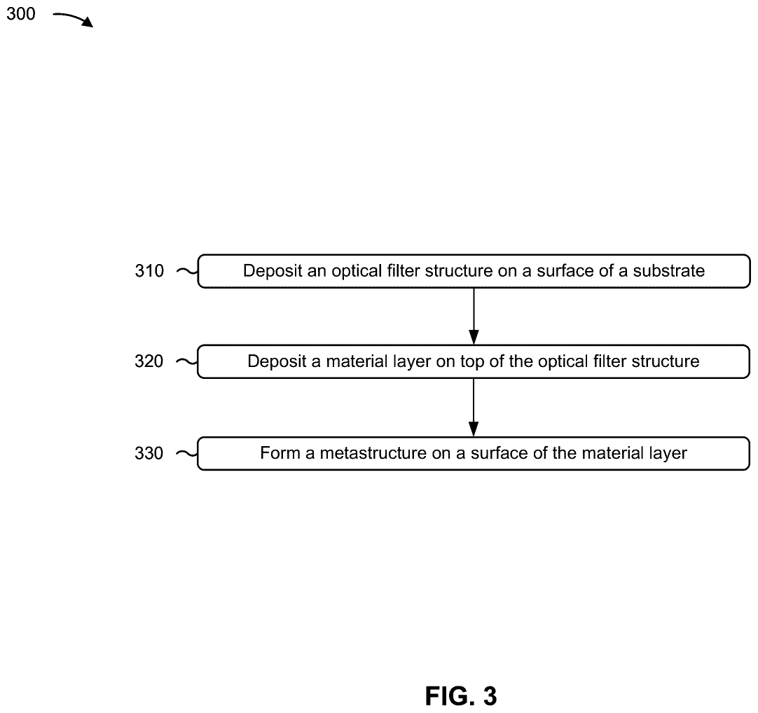

FIG. 3 is a flowchart of an example process 300 associated with manufacturing a multilayer optical coating with metastructures. In some implementations, one or more process blocks of FIG. 3 are performed by a device (e.g., a manufacturing device, such as a sputter deposition device, an etching device, or another type of device).

As shown in FIG. 3, process 300 may include depositing an optical filter structure on a surface of a substrate (block 310). For example, the device may deposit an optical filter structure on a surface of a substrate, as described above. In some implementations, the optical filter structure includes a first one or more layers of a first material and a second one or more layers of a second material. In some implementations, the optical filter structure is deposited using a sputter deposition process. For example, a sputter deposition device may sputter a set of material layers on a substrate to form a multi-layer optical coating on the surface of the substrate. Additionally, or alternatively, the sputter deposition device may sputter a thin film layer on the surface of the substrate. In some implementations, a thickness, order, pattern, or other characteristic of one or more layers deposited on the substrate may be selected to achieve an optical filter functionality. In some implementations, the substrate may have multiple optical filter structures formed thereon. For example, the substrate may have multiple optical filter structures formed on a single side of the substrate or on the multiple sides of the substrate.

As further shown in FIG. 3, process 300 may include depositing a material layer on top of the optical filter structure (block 320). For example, the device may deposit a material layer on top of the optical filter structure, as described above. In some implementations, the optical filter structure is positioned between the material layer and the substrate. For example, an amorphous silicon layer or other material layer may be deposited on top of an optical filter structure to provide for forming a metastructure. Additionally, or alternatively, an amorphous silicon layer may be deposited on a bottom of the substrate. In this case, a pair of amorphous silicon layers sandwich the substrate and the optical filter structure to form an optical filter assembly, which is to be patterned with a set of metastructures.

As further shown in FIG. 3, process 300 may include forming a metastructure on a surface of the material layer (block 330). For example, the device may form a metastructure on a surface of the material layer, as described above. In this case, the device may pattern, etch, or imprint on a surface of the material layer to form a metastructure. Additionally, or alternatively, the device may pattern, etch, or imprint on another surface of another material layer to form another metastructure (e.g., on another side of the substrate). In this case, opposing surfaces of the optical filter assembly are a pair of metastructures, separated by a substrate and an optical filter structure.

Process 300 may include additional implementations, such as any single implementation or any combination of implementations described below and/or in connection with one or more other processes described elsewhere herein.

In a first implementation, the optical filter structure is associated with a first thickness and the material layer is associated with a second thickness that is larger than the first thickness.

In a second implementation, alone or in combination with the first implementation, process 300 includes depositing, by the device, another material layer on the substrate, such that the substrate is positioned between the other material layer and the optical filter structure, and forming, by the device, another metastructure on another surface of the other material layer.

In a third implementation, alone or in combination with one or more of the first and second implementations, process 300 includes depositing another optical filter structure on another surface of the substrate, such that the substrate is positioned between the optical filter structure and the other optical filter structure.

Although FIG. 3 shows example blocks of process 300, in some implementations, process 300 includes additional blocks, fewer blocks, different blocks, or differently arranged blocks than those depicted in FIG. 3. Additionally, or alternatively, two or more of the blocks of process 300 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An optical filter assembly, comprising:
a first optical element disposed on a first side of a substrate,
wherein the first optical element includes a first metasurface structure;
a second optical element disposed on a second side of the substrate,
wherein the second optical element includes a second metasurface structure; and
a multi-layer optical coating disposed between the first optical element and the second optical element.

2. The optical filter assembly of claim 1, wherein the multi-layer optical coating includes an optical filter.

3. The optical filter assembly of claim 1, wherein the optical filter includes a bandpass filter.

4. The optical filter assembly of claim 1, wherein the multi-layer optical coating includes three or more layers.

5. The optical filter assembly of claim 1, wherein the multi-layer optical coating includes alternating layers of a first material and a second material.

6. The optical filter assembly of claim 5, wherein the first material is associated with a refractive index less than a first value and the second material is associated with a refractive index greater than a second value, and wherein a difference between the first value and the second value is at least a threshold difference.

7. The optical filter assembly of claim 1, wherein at least one of the first optical element or the second optical element includes a lens.

8. The optical filter assembly of claim 1, wherein at least one of the first metasurface structure or the second metasurface structure includes a set of nanopillars disposed on a surface.

9. The optical filter assembly of claim 8, wherein the set of nanopillars form a grid arrangement.

10. The optical filter assembly of claim 8, wherein the set of nanopillars forms an irregular arrangement.

11. The optical filter assembly of claim 8, wherein the surface is an amorphous silicon surface.

12. The optical filter assembly of claim 1, wherein the substrate is a glass substrate.

13. A method, comprising:
depositing, by a device, an optical filter structure on a surface of a substrate,
wherein the optical filter structure includes a first one or more layers of a first material and a second one or more layers of a second material;
depositing, by the device, a material layer on top of the optical filter structure, such that the optical filter structure is positioned between the material layer and the substrate; and
forming, by the device, a metastructure on a surface of the material layer.

14. The method of claim 13, wherein the optical filter structure is associated with a first thickness and the material layer is associated with a second thickness that is larger than the first thickness.

15. The method of claim 13, further comprising:
depositing, by the device, another material layer on the substrate, such that the substrate is positioned between the other material layer and the optical filter structure; and
forming, by the device, another metastructure on another surface of the other material layer.

16. The method of claim 13, further comprising:
depositing another optical filter structure on another surface of the substrate, such that the substrate is positioned between the optical filter structure and the other optical filter structure.

17. An optical system, comprising:
an electro-optic component; and
a composite optical filter aligned to the electro-optic component, the composite optical filter including:
a first optical metastructure on a first side of the composite optical filter;
a second optical metastructure on a second side of the composite optical filter; and
a multi-layer optical filter disposed between the first optical metastructure and the second optical metastructure.

18. The optical system of claim 17, wherein the electro-optic component is an optical emitter configured to emit at a configured center wavelength.

19. The optical system of claim 17, wherein the electro-optic component is an optical detector configured to detect at a configured center wavelength.

20. The optical system of claim 17, wherein the multi-layer optical filter includes an alternating arrangement of one or more high refractive index layers and one or more low refractive index layers.
